(19) United States
(12) Patent Application Publication
(10) Pub. No.: US 2026/0237998 A1
(43) Pub. Date: Aug. 13, 2026

(54) DEVICE, METHOD AND COMPUTER PROGRAM PRODUCT FOR PRIORITISING SWITCHING OFF OF ELECTRICAL CIRCUITS

(71) Applicant: Phoenix Contact GmbH & Co. KG, Blomberg (DE)

(72) Inventors: Lars ALSDORF, Soest (DE); Alexander HANEKE, Geseke (DE); Stelios THEODORIDIS, Gerakas (GR)

(21) Appl. No.: 19/474,733

(22) PCT Filed: Apr. 12, 2024
(86) PCT No.: PCT/EP2024/059950

§ 371 Date: Nov. 10, 2025

(30) Foreign Application Priority Data
Apr. 13, 2023 (LU) LU503928

(51) Int. Cl. H02H 7/00; H02J 1/08

(52) U.S. Cl. CPC H02H 7/008; H02J 1/084

(57) ABSTRACT

A device for avoiding a power supply unit overload includes: a first power supply connection of a first load; a second power supply connection of a second load, the first power supply connection and the second power supply connection being electrically supplied by an upstream power supply unit; a receiving unit for receiving a measured value of a power capability of the upstream power supply unit; and a controller for performing at least one shutoff of the first power supply connection or the second power supply connection upon exceeding the power capability of the upstream power supply unit. The power supply connection with a greatest present current load or the greatest present power draw is shut off.

### CROSS REFERENCE TO RELATED APPLICATIONS

This application is a U.S. National Phase application under 35 U.S.C. § 371 of International Application No. PCT/EP2024/059950, filed on Apr. 12, 2024, and claims benefit to Luxembourg Patent Application No. LU503928, filed on Apr. 13, 2023. The International Application was published in German on Oct. 17, 2024 as WO 2024/213698 A1 under PCT Article 21(2).

### FIELD

The invention relates to avoiding an overload of a power supply unit, preferably a power supply unit for low voltages. A plurality of loads, each with its own power supply connection, also called power supply element, can be connected to the power supply unit, whose respective current limitation in sum exceeds the power capability of the power supply unit. In this case, the supply voltage of the power supply unit may drop, which can lead to failure or impairment of the connected loads.

### BACKGROUND

Preferably, the invention relates to current draws of several power supply connections (power supply element) each within the permitted range. In other words, a current smaller than the respective maximum current, also called rated current, is drawn from each power supply connection. In this case, shutoff mechanisms of the current limitation of the individual power supply connections do not intervene. In sum, however, the currents of all power supply connections can exceed the power capability of the upstream power supply unit, since the power supply units are not designed with larger power reserves for unforeseen high cumulative current consumptions of all power supply connections for economic reasons.

Preferably, low-voltage systems according to SELV (Safety Extra Low Voltage) and PELV (Protective Extra Low Voltage) can comprise low-voltage systems with a DC voltage <60 VDC (direct current) of for example 12 VDC or 24 VDC. Several parallel-connected power supply connections (power supply elements) for electronic protection of loads are connected to these power supply units. Each of the power supply connections interrupts, like a fuse, the supplied circuit when a rated current is exceeded, to protect the connected loads, for example devices and lines, from overload. The rated current, also called trigger current, of the respective power supply connection is optionally adjustable in different steps, whereby it is possible that the sum of all rated currents is above the power capacity of the upstream power supply unit. In this case, the supply voltage of the power supply unit drops and proper operation of the loads is no longer guaranteed.

### SUMMARY

In an embodiment, the present disclosure provides a device for avoiding a power supply unit overload, comprising: a first power supply connection of a first load; a second power supply connection of a second load, the first power supply connection and the second power supply connection being electrically supplied by an upstream power supply unit; a receiving unit configured to receive a measured value of a power capability of the upstream power supply unit; and a controller configured to perform at least one shutoff of the first power supply connection or the second power supply connection upon exceeding the power capability of the upstream power supply unit, wherein the power supply connection with a greatest present current load or the greatest present power draw is shut off.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 a schematic circuit diagram of an inventive device in a first aspect,

FIG. 2 a schematic circuit diagram of an inventive device in a first embodiment,

FIG. 3 a schematic circuit diagram of an inventive device in a second embodiment,

FIG. 4 a schematic circuit diagram of an inventive device in a third embodiment,

FIG. 5 a schematic circuit diagram of an inventive device in a fourth embodiment,

FIG. 6 a schematic circuit diagram of an inventive device in a fifth embodiment,

FIG. 7A a schematic circuit diagram of a known system,

FIG. 7B a schematic circuit diagram of an inventive system in a second aspect,

FIG. 7C a schematic circuit diagram of an inventive system in a first embodiment, and

FIG. 8 a schematic circuit diagram of an inventive method in a third aspect.

### DETAILED DESCRIPTION

In an embodiment, the present invention provides a technique which reduces the current consumption of the loads when the power supply unit rated current is exceeded.

Embodiments of the invention, which can optionally be combined with each other, are disclosed below with partial reference to the figures.

A first aspect relates to a device for avoiding a power supply unit overload. The device comprises a first power supply connection (power supply element) of a first load and a second power supply connection of a second load. The first power supply connection and the second power supply connection can be electrically supplied by an upstream power supply unit. The device further comprises a receiving unit for receiving a measured value of a power capability of the upstream power supply unit. In addition, the device comprises a controller that is configured to perform at least one shutoff of the first power supply connection or the second power supply connection upon exceeding the power capability of the upstream power supply unit. The power supply connection with the greatest present current load or the greatest present power draw can be shut off.

The device, also called module, can be configured for mounting in a control cabinet, for example with fastening elements for control cabinet rails. These can be configured as DIN mounting rails.

The power supply connections (power supply elements) can comprise connection terminals for connecting loads. The terminals can be designed for electrical connection with cables for electrical connection with the load. The terminals can be implemented as screw connections and/or as spring-clamp connections and additionally or alternatively also as push-in or push-X direct plug-in technology. The contacting of the conductor of the cable takes place with low or completely without force by inserting the conductor into a contact spring or by lightly tapping a trigger surface within a terminal chamber. Furthermore, the power supply connections can comprise shutoff devices for shutting off the power supply for the respectively connected load or loads. The shutoff devices can be communicatively coupled to the controller. The power supply connections can be configured as DC (direct current) power sources. The power supply connections (power supply elements) can be connected to a current/voltage source within the device.

The receiving unit is configured to receive a measured value or to set a power capability of the upstream power supply unit. Accordingly, the receiving unit can also be referred to as a setting unit. The measured value of the power capability can be configured as a parameter that indicates, for example, the present power capability of the upstream power supply unit. This can comprise, for example, the present rated current of the upstream power supply unit.

The controller can comprise a processor or microcontroller. It is communicatively coupled to the receiving unit and the plurality of power supply connections (power supply elements), wherein the power supply connections are individually addressable. The controller can additionally comprise memory, a bus system and drivers for receiving and forwarding signals of the communication links.

The exceedance of the power capability of the upstream power supply unit can include a safety margin or a tolerance margin. For example, shutoff can occur when a present power (or a corresponding current) of the upstream power supply unit reaches or exceeds 80% or 90% or 95% (or similar) of a maximum power capability. The reaching or exceeding of the power capability or the maximum power capability can be detected by measuring a voltage drop (for example at the output) of the upstream power supply unit (for example by the controller).

The present current load can refer to the current presently drawn at the respective power supply connection (power supply element). The greatest present current load can refer to a comparison between the first power supply connection and the second power supply connection or to the greatest present current load of all power supply connections of a first set of power supply connections (which comprises at least the first power supply connection and the second power supply connection).

Advantageously, the greatest current saving can thus be achieved when the power supply unit is overloaded.

In embodiments, the controller can further be configured to receive a measured value of the power capability of the upstream power supply unit via an interface of the receiving unit. Alternatively or additionally, the power capability of the upstream power supply unit can be locally adjustable in the receiving unit. Additionally or alternatively, the setting of the power capability can also be stored.

The adjustability can be configured as a local switch position or as a data item in a local memory of the receiving unit. It can comprise a stepwise setting of different values of the power capability. The interface can receive a signal from the power supply unit, which can be configured, for example, as a measured value. The signal can be of electrical or optical nature. Preferably, the signal can be configured as a signal for a data bus. Furthermore, the signal can be static or variable. The receiving unit permanently evaluates the applied signal. The receiving unit is communicatively coupled to the controller and transmits the content of the signal to the controller.

Advantageously, in one embodiment, a signal connection of the device with the power supply unit can be dispensed with. In the alternative embodiment, a separate setting of the power capability in the device can advantageously be dispensed with and additionally the dynamic change of a signal of the signal connection can be taken into account.

In other embodiments, the power capability of the upstream power supply unit can be variable. Optionally, the variance can occur depending on the magnitude of a total current load of the upstream power supply unit. Alternatively or additionally, the variance can be based on a change in the total current load of the upstream power supply unit. Further alternatively or additionally, the variance can be based on the ambient temperature. The ambient temperature of the upstream power supply unit and additionally optionally the ambient temperature of the device can be taken into account. Alternatively or additionally, the variance can be based on the input voltage of the power supply unit. Further alternatively or additionally, the variance can be based on a prior loading of the power supply unit. Alternatively or additionally, the variance can be based on the absolute output voltage of the power supply unit.

The absolute output voltage is that output voltage of the power supply unit that is present at its output terminals without exceeding the total current load of the power supply unit. A relative output voltage is present at the loads and can be smaller than the absolute output voltage due to losses in the device and due to line losses between device and load.

The total current load of the upstream power supply unit results from the sum of all current consumptions of all power supply connections (power supply elements), supplemented by the current consumption of the remaining components of the device. This can be measured in the device, in particular before the branching of the total current to the individual parallel-connected power supply connections.

A prior loading of the low-voltage power supply unit can comprise taking into account the temperature of its own components. This can be measured by temperature sensors. Additionally or alternatively, it can also be calculated, for example taking into account the previous power delivered by the low-voltage power supply unit within a just elapsed time period.

The absolute output voltage of the low-voltage power supply unit can be adjustable between 24V-29V. The current limit is thereby constant-power. The absolute output voltage can be measured and used for internal control of the output voltage of the low-voltage power supply unit.

Advantageously, the presently available power capability of the power supply unit can thus be utilized, so that unnecessary shutoff of power supply connections is avoided.

In embodiments, the first power supply connection (power supply element) can be configured as a first protection path for preventing an exceedance of a first rated current. Additionally, the second power supply connection can be configured as a second protection path for preventing an exceedance of a second rated current. The power capability of the upstream power supply unit is smaller than the sum of the rated currents.

The rated currents are the maximum currents of the individual power supply connections. When a rated current is exceeded, the associated power supply connection is shut off. There is no effect on other power supply connections of the same device.

Each protection path can comprise a protective switch. The protective switch can be configured to interrupt the protection path when the respective rated current is exceeded. The protective switch can be configured as a fuse. This can comprise a melting fuse or an electronic fuse, which in turn can comprise a fault current measurement. The protective switch can be configured such that a temporary exceedance of the rated current does not lead to shutoff. The shutoff takes place in this case only after a predetermined time, for example after 3 or 5 seconds, wherein particularly when using melting fuses the predetermined time is subject to considerable fluctuations, for example +/−40%. Thus, in particular short-term current exceedances that typically occur during a motor start are harmless.

Advantageously, it can thus be prevented that faults of individual loads of individual power supply connections (power supply elements) take the entire power supply out of operation.

In further embodiments, the first protection path and additionally or alternatively the second protection path can comprise an output current measurement via a shunt resistor or a Hall sensor. Optionally, the output current measurement can be evaluated in the controller taking into account a current reserve.

A shunt resistor, also referred to as a shunt resistor or bypass resistor, refers to an electrically conductive component that is connected in parallel to a part of a circuit to divert an electrical current from that part. Hall sensors are passive sensors that measure a voltage difference generated across an electrical conductor when a magnetic field is perpendicular to the flow direction of an electrical current.

A current reserve refers to the availability of a short-term current greater than the rated current. Typically, a current reserve can comprise three to seven and a half times the rated current for the duration of, for example, 3-5 milliseconds or also 3-5 seconds. Typically, the current reserve can be used during a motor start to avoid premature shutoff of the power supply connection. The current reserve can be adjustable, for example implemented with a switch or as a signal receivable by the device.

Advantageously, the current measurements are thus carried out cost-effectively and at the same time premature current shutoff can be avoided.

In other embodiments, the device can comprise a third power supply connection (power supply element) of a third load, which is configured as a third protection path for preventing an exceedance of a third rated current. Upon persistent exceedance of the power capability of the upstream power supply unit, the controller performs a shutoff of the power supply connection with the greatest present current load from the set of the non-shutoff power supply connections.

The third power supply connection is arranged in parallel to the first power supply connection, which in turn can be arranged in parallel to the second power supply connection.

After shutoff of one of the three power supply connections (power supply elements), the power capability of the power supply unit may still be exceeded. In this case, the present current consumption of the two remaining power supply connections is sensed. The power supply connection with the highest current is shut off to fall below the power capability limit of the power supply unit.

Accordingly, a multi-stage shutoff procedure can advantageously comprise shutting off the power supply connection with the respectively highest present current consumption, as long as until the power capability of the power supply unit is no longer exceeded.

In embodiments, the rated currents of the different power supply connections (power supply elements) can have an identical magnitude or at least partially mutually different magnitudes. Alternatively or additionally, the magnitude of the rated current can be adjustable in steps. For each power supply connection, the rated current can be set independently of the rated currents of the other power supply connections.

Advantageously, an individual setting of the rated currents can thus be made.

In other embodiments, the device can comprise further power supply connections. For the further power supply connections, a user-selected priority can be adjustable that is higher or lower than a priority of the power supply connections.

That is, the further power supply connections (power supply elements) can have a higher or lower priority than the power supply connections (e.g., the first power supply connection and the second power supply connection). The priority can relate to the shutoff of a power supply connection or a further power supply connection. For example, the further power supply connections with the higher priority may not be affected by the shutoff (at least initially), while the power supply connections with the lower priority are at least partially shut off according to the greatest present current load.

Alternatively or additionally, the device can comprise a first set of power supply connections (power supply elements). The first set can comprise the first power supply connection and the second power supply connection (and optionally the above-mentioned third power supply connection). The device can further comprise a second set of power supply connections (power supply elements) disjoint from the first set. The second set can comprise the further power supply connections. The controller can be configured to shut off, among the power supply connections of the first set, the one with the greatest present current load, for example regardless of the present current load of the second set. The controller can further be configured to shut off, among the further power supply connections of the second set, the one with the greatest present current load when all power supply connections of the first set are already shut off.

The priority can be permanently (e.g., hard-wired) assigned to the respective power supply connection (power supply element). A user can select the priority by selecting the power supply connection. Alternatively, the priority can be adjustable at the respective connection (e.g., by parameterization of the controller, for instance via an interface or by a switch at the respective connection).

Advantageously, power supply connections can thus be shut off in a more differentiated manner in case of exceeding the power capability of the upstream power supply unit.

In embodiments, the controller can be configured to perform at least one shutoff of the power supply connections (power supply elements) or the further power supply connections (power supply elements) according to the priority upon exceeding the power capability of the upstream power supply unit. The power supply connections at lower priority can be shut off first, for example in several steps. Alternatively, the further power supply connections at lower priority can be shut off first, for example also in several steps.

Accordingly, the power supply connections or the further power supply connections with higher priority are advantageously at least initially not shut off, regardless of the respective present current consumption.

In further embodiments, for the power supply connections (power supply elements) and for the further power supply connections (power supply elements), the user-selected priority can be set via software or by a switch. Optionally, the setting can be made at one of the further power supply connections.

The switch or switches or a memory for the software settings of the priority can be arranged in the receiving unit. Additionally or alternatively, the structural design of the further power supply connections can differ from the structural design of the power supply connections, so that the priority can be set at at least one of the further power supply connections.

Upon detection of an overload of the power supply unit, a querying of the priorities for the power supply connections and the further power supply connections can take place. Advantageously, the priority can thus be set in various ways.

A second aspect relates to a method for avoiding a power supply unit overload according to the first aspect or one or more embodiment(s) of the first aspect. In other words, the second aspect comprises a method for avoiding a power supply unit overload. This comprises the following steps: Sensing a first current of a power supply connection (power supply element) of a first load. The method further comprises sensing a second current of a second power supply connection (power supply element) of a second load. The first power supply connection and the second power supply connection are electrically supplied by an upstream power supply unit. The method further comprises receiving, with a receiving unit, a measured value for the power capability of the upstream power supply unit. In addition, the method comprises controlling, with a controller, upon exceedance of the power capability of the upstream power supply unit by at least one shutoff of the first power supply connection or the second power supply connection. Finally, the method comprises shutting off the power supply connection with the greatest present current load or the greatest present power draw.

Advantageously, the greatest current saving can thus be achieved when the power supply unit is overloaded.

A third aspect relates to a system for avoiding a power supply unit overload. This comprises a device according to the first aspect and optionally the associated embodiments. The system further comprises a power supply unit. The power supply unit and the device are electrically connected for supplying the device with electrical power. Furthermore, the power supply unit and the device have a communication link, wherein a signal of the communication link comprises information or a measured value about the power capability of the power supply unit.

The power supply unit, also referred to as upstream power supply unit, can be configured as a switching power supply unit or as a power supply unit with a transformer. In particular, the power supply unit can be configured as a low-voltage power supply unit. It can have a parameterizable absolute output voltage that is adjustable, for example, between 24V-29V. It can additionally be configured as constant-power, so that when the power supply unit rated current is exceeded, the voltage provided by the power supply unit drops. Furthermore, the power supply unit can have an adjustable shutoff threshold that is adjustable analogically via a switch or a potentiometer or digitally via an interface.

Settings of the shutoff thresholds can be made by components of the power supply unit analogically via switches and additionally or alternatively via potentiometers. Additionally or alternatively, the settings can also be made digitally via an interface. The power supply unit, also called electrical power supply, can be set such that a voltage can be set within certain voltage limits (but also comprehensively for the power). The respective parameters of the limitation for output voltage and current or power can be adjusted accordingly. With the adjustment/parameterization, it is possible to adapt an output characteristic of the power supply unit to the respective requirements to be suitable for a variety of applications.

By parameterizing the limit values of the power supply unit (voltage limit, rated current or current limit), the power supply unit can be adapted, for example, to safety requirements or set to a reduced cable load. Thus, for example, depending on the cable length, it is typically known which voltage drop occurs across this cable at a known current. The output characteristic of the output voltage of the power supply unit can be set such that the voltage drop across the line is compensated, so that the desired nominal voltage, for example 12V or 24V, is present at the load.

The low-voltage power supply unit can be configured according to SELV (Safety Extra Low Voltage) or PELV (Protective Extra Low Voltage) low-voltage systems with a DC voltage <60 VDC (direct current) of for example 12 VDC or 24 VDC.

The signal can be configured as a signal for a data bus. Alternatively or additionally, it can also be configured as a digital signal or as an analog signal.

Furthermore, the low-voltage power supply unit can comprise a pre-alarm threshold. Upon activation of the pre-alarm threshold, the low-voltage power supply unit shuts off its power output prior to a drop of its output voltage, which results in a shutoff of all power supply connections (power supply elements). This can prevent voltage undersupply of the loads.

Advantageously, a compact form factor can be achieved by the system, which is configured, for example, in a housing for mounting on DIN mounting rails.

In embodiments, the device and the power supply unit of the system can be implemented as an integrated component. The integrated component can be realized by the device and the upstream power supply unit being arranged in a housing. Additionally or alternatively, the device and the upstream power supply unit can be arranged on a circuit board.

The housing can provide a spatial partition, in one part of which the power supply unit and in the other part of which the device is arranged. This can also be the case at least partially with the arrangement of the device and the upstream power supply unit on a circuit board.

Advantageously, a compact design can thus be achieved.

In further embodiments, the upstream power supply unit can be configured as constant-power. Optionally, the upstream power supply unit can have an adjustable absolute output voltage.

The constant-power characteristic describes the presence of the set absolute output voltage at the output terminals of the power supply unit, as long as the secondary-side total current of the power supply unit for the absolute output voltage is not exceeded. The adjustability of the absolute output voltage of the power supply unit can be done manually via a switch or via a further interface of the power supply unit. The voltage losses from the device and cabling are essentially known. Thus, depending on the type of device and cabling used, the relative output voltage, i.e., the input voltage at the load, can be pre-set based on empirical values by setting the absolute output voltage. Alternatively or additionally, the setting can be made via a further interface of the power supply unit.

Advantageously, the current draw from the power supply unit can thus take place up to the rated current without voltage drop, while at the same time the input voltage at the loads can be pre-set.

A fourth aspect relates to a computer program product for avoiding a power supply unit overload, comprising instructions that cause one of the devices of the first aspect to execute the method of the second aspect.

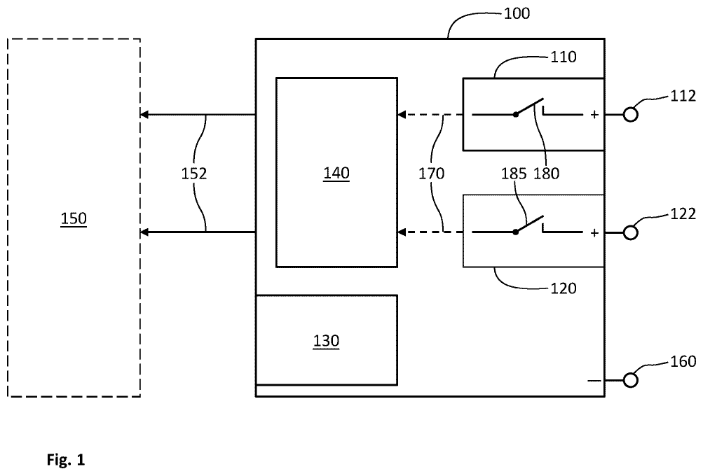

FIG. 1 shows a schematic circuit diagram of a device 100 in a first aspect. A device 100 for avoiding a power supply unit overload is shown. The device can also be referred to as a module or as a multi-channel selectivity module. This comprises a first power supply connection (power supply element) 110 of a first load as well as a second power supply connection (power supply element) 120 of a second load. The power connections 110, 120 can be implemented as DC (direct current) connections. They have connection elements 112, 122, which can be configured as positive conductors, also called positive pole. Additionally, a ground conductor 160 is present for the common current return of the loads, which is also known as negative pole. The first power supply connection 110 and the second power supply connection 120 are electrically supplied by an upstream power supply unit 150. The device 100 further comprises a receiving unit 130 for receiving a measured value of a power capability of the upstream power supply unit 150. In addition, the device 100 comprises a controller 140 that is configured to perform at least one shutoff of the first power supply connection 110 or the second power supply connection 120 upon exceeding the power capability of the upstream power supply unit 150. The power supply connection 110, 120 with the greatest present current load or the greatest present power draw is shut off. Power supply unit 150 and device 100 are connected by means of electrical lines 152 for power transfer. The first power supply connection 110 comprises a first shutoff element 180 and the second power supply connection 120 comprises a second shutoff element 185. The shutoff elements 180, 185 serve to shut off the respective power supply, in particular when the power supply unit is overloaded. The shutoff of the shutoff elements 180, 185 can be initiated by the controller. Output current measurements 170 of the first power supply connection and the second power supply connection are reported from the first power supply connection 110 and from the second power supply connection 120 to the controller 140.

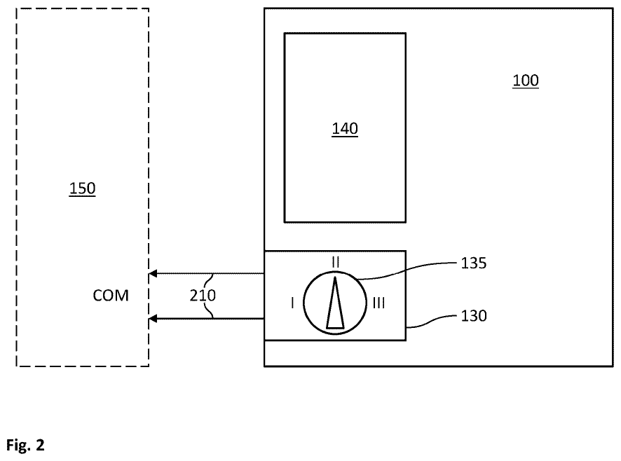

FIG. 2 shows a schematic circuit diagram of a device 100 in a first embodiment. The controller 140 is further configured to receive a measured value of the power capability of the upstream power supply unit 150 via an interface 210 of the receiving unit 130. Alternatively or additionally, the power capability of the upstream power supply unit 150 can be locally adjustable and/or stored in the receiving unit 130. The adjustability can be made using a switch 135, which can have a plurality of switch positions. In FIG. 2, three switch positions are shown by way of example, which correspond to three different power levels of the power supply unit 150. More or fewer switch positions and corresponding power capabilities of the power supply unit 150 can also be set. The setting can also be stored in a memory.

The power capability of the upstream power supply unit 150 can be variable. Optionally, the variance can depend on the magnitude of a total current load. Alternatively or additionally, the variance can depend on a change in the total current load. Further alternatively or additionally, the variance can depend on an ambient temperature of the power supply unit 150. Additionally alternatively or additionally, the variance can depend on the input voltage of the power supply unit 150. Alternatively or additionally, the variance can depend on a prior loading and further alternatively or additionally, the variance can depend on the absolute output voltage of the power supply unit 150. The magnitude of a total current load, the change in the total current load, the ambient temperature, the input voltage, the prior loading and/or the absolute output voltage of the power supply unit 150 can be signaled via the interface 210 from power supply unit to device. Accordingly, the signaling can be used in the device to determine the power capability of the power supply unit 150.

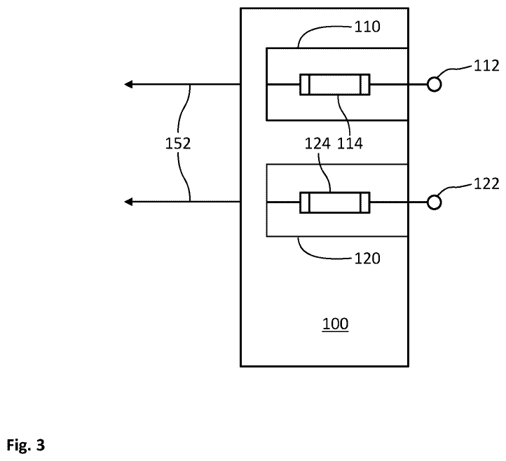

FIG. 3 shows a schematic circuit diagram of a device 100 in a second embodiment. The device 100 comprises the first power supply connection (power supply element) 110 and the second power supply connection (power supply element) 120. The first power supply connection 110 comprises a first protection path 114 that is configured for preventing an exceedance of a first rated current of the first power supply connection 110. The second power supply connection 120 comprises a second protection path 124 that is configured for preventing an exceedance of a second rated current of the second power supply connection 120. The power capability of the upstream power supply unit 150 can be smaller than the sum of the rated currents of the first power supply connection 110 and the second power supply connection 120. FIG. 3 further shows the voltage and current supply 152 of the device 100.

The first protection path 114 and alternatively or additionally the second protection path 124 can comprise an output current measurement via a shunt resistor or a Hall sensor. Optionally, the output current measurement can be evaluated in the controller 140 taking into account a current reserve.

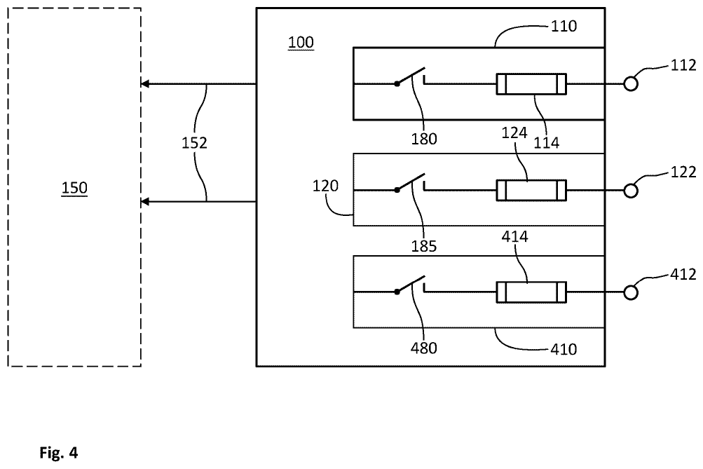

FIG. 4 shows a schematic circuit diagram of a device 100 in a third embodiment. In addition to the first power supply connection (power supply element) 110 and the second power supply connection (power supply element) 120, the device 100 comprises a third power supply connection (power supply element) 410 of a third load or for connecting a third load. The third power supply connection 410 comprises a third protection path 414 that is configured for preventing an exceedance of a third rated current, the rated current of the third power supply connection 410. Upon persistent exceedance of the power capability of the upstream power supply unit 150, the controller performs a shutoff of the power supply connection with the greatest present current load from the set of the non-shutoff power supply connections 110, 120, 410. The persistent exceedance of the power capability of the upstream power supply unit 150 can last from a few milliseconds to a few seconds. Typical are 3-5 milliseconds and 2-3 seconds. FIG. 4 further shows the voltage and current supply 152 of the device 100.

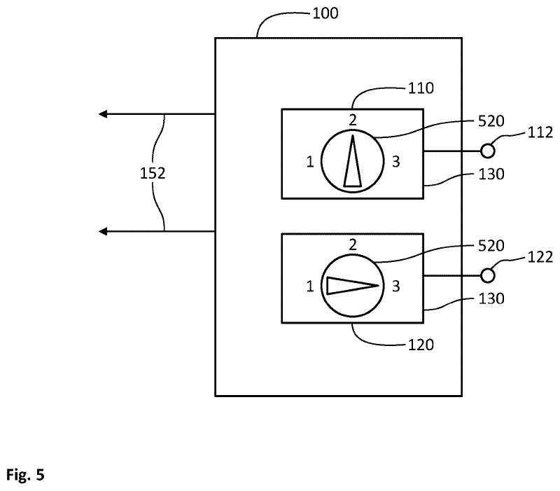

FIG. 5 shows a schematic circuit diagram of a device 100 in a fourth embodiment. The device 100 shows the first power supply connection (power supply element) 110 and the second power supply connection (power supply element) 120. For both power supply connections 110, 120, the rated currents can have an identical magnitude. Alternatively, the rated currents can have mutually different magnitudes. In addition, the magnitude of the rated currents can be adjustable in steps 510, 520. Switches can be used for these settings, as sketched in FIG. 5. The switches are configured with three positions, which is however only chosen as an example. More, for example 5 or 7 settings, or fewer, for example 2 settings, are also possible. The switch positions shown are also to be understood as merely exemplary.

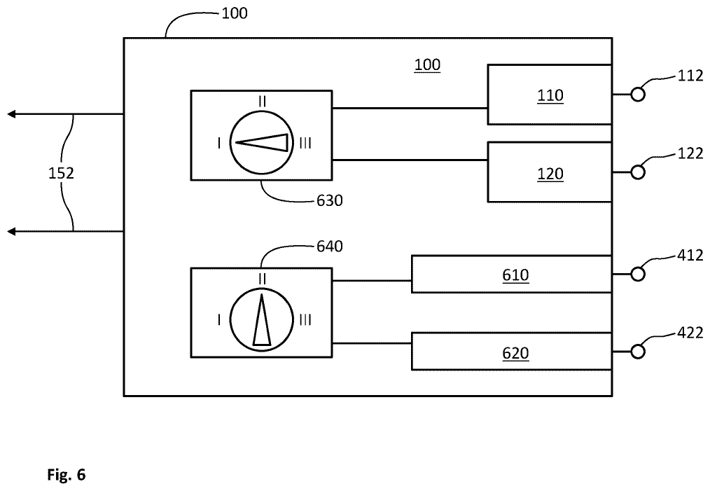

FIG. 6 shows a schematic circuit diagram of a device 100 in a fifth embodiment. In addition to the first power supply connection (power supply element) 110 and the second power supply connection (power supply element) 120, the device 100 comprises further power supply connections (power supply elements) 610, 620. Both the power supply connections 110, 120 and the further power supply connections 610, 620 each have a priority determination element 630, 640. This can be configured as a switch, as shown. For the further power supply connections 610, 620, a user-selected priority 640 can be set that is higher or lower than a priority 630 of the power supply connections 110, 120. Likewise, for the power supply connections 110, 120, a user-selected priority 630 can be set. Again, the number of switch positions as well as the shown position of the switches is merely shown as an example and does not represent a limitation.

The controller 140 is configured to perform at least one shutoff of the power supply connections 110, 120 or the further power supply connections 610, 620 according to the priorities 630, 640 upon exceeding the power capability of the upstream power supply unit 150. The power supply connections 110, 120 are shut off first at lower priority. Alternatively, the further power supply connections 610, 620 are shut off first at lower priority.

For the power supply connections 110, 120 and the further power supply connections 610, 620, the user-selected priority can be set via software or by a switch. Optionally, the setting can be made at at least one of the further power supply connections 610, 620.

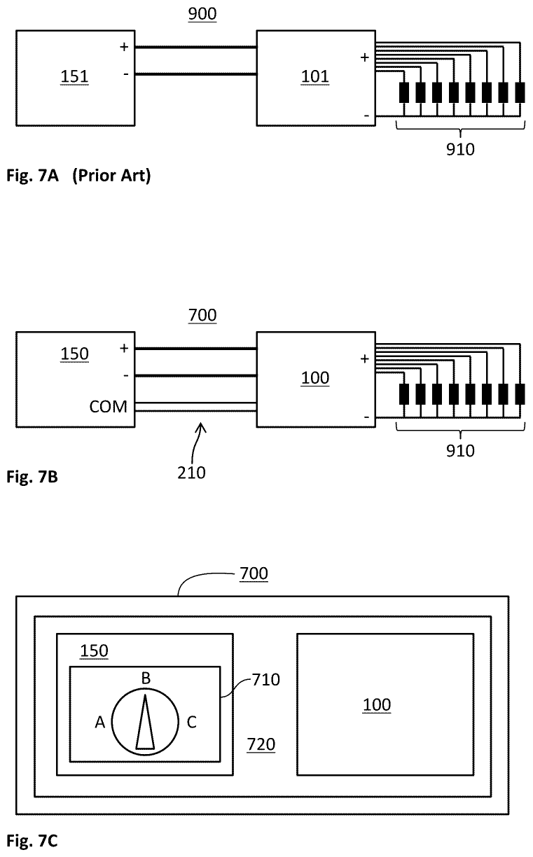

FIG. 7A shows a schematic circuit diagram of a known arrangement 900 from the prior art. The known arrangement 900 comprises a standalone power supply unit 151 and a standalone device 101. An electrical connection provides the device 101 with power from the power supply unit 151. Furthermore, the device 101 is electrically connected to a plurality of loads 910. Beyond that, there are no connections between the power supply unit 151 and the device 101, which can also be arranged spatially separated from each other. Accordingly, the device 101 has no information about the power capability of the power supply unit 151, in particular no information about the present power capability of the power supply unit 151.

FIG. 7B shows a schematic circuit diagram of a system 700 in a second aspect. A system 700 for avoiding a power supply unit overload is shown. The system 700 comprises a device 100 and a power supply unit 150. The power supply unit 150 and the device 100 are electrically connected for supplying the device 100 with electrical power from the power supply unit 150. Furthermore, the power supply unit 150 and the device 100 have a communication link 210 in contrast to the arrangement 900 of FIG. 7A. A signal of the communication link 210 comprises information about the power capability of the power supply unit 150. Furthermore, it can also comprise parameters on which a determination of the power capability of the power supply unit can be based, such as the temperature of the power supply unit or the like. FIG. 7B also shows a plurality of loads 910 that can be connected to the system 700.

FIG. 7C shows a schematic circuit diagram of a system 700 in a first embodiment. The system 700 comprises the device 100 and the power supply unit 150. These are implemented as an integrated component 720. In one embodiment, this can comprise placing device 100 and power supply unit 150 on a circuit board, which is understood as a component. Alternatively, device 100 and power supply unit 150 can also be arranged in a common housing. This can optionally also be potted, for example with synthetic resin.

The upstream power supply unit 150 can be configured as constant-power. Optionally, the upstream power supply unit 150 can have an adjustable absolute output voltage 710. This is implemented in FIG. 7C as an example as a three-position switch. This does not exclude alternative embodiments.

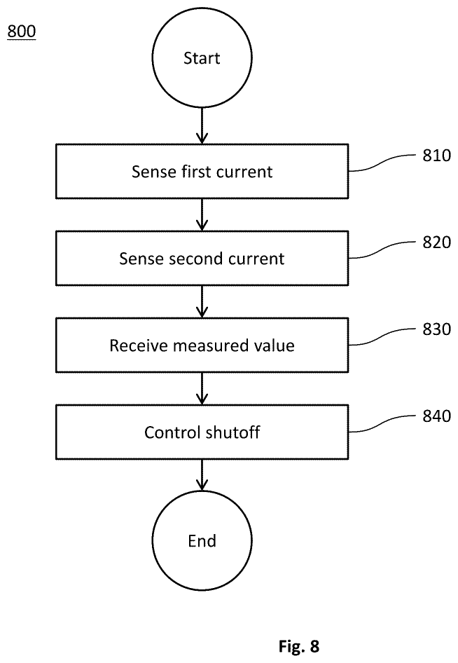

FIG. 8 shows a schematic circuit diagram of a method 800 in a third aspect. The method 800 for avoiding a power supply unit overload comprises the following steps: Sensing 810 a first current of a power supply connection (power supply element) 110 of a first load. The method further comprises sensing 820 a second current of a second power supply connection (power supply element) 120 of a second load. The first power supply connection 110 and the second power supply connection 120 are electrically supplied by an upstream power supply unit 150. The method further comprises receiving 830, with a receiving unit 130, a measured value for the power capability of the upstream power supply unit 150. Furthermore, the method comprises controlling 840, with a controller 140, upon exceedance of the power capability of the upstream power supply unit 150 at least one shutoff of the first power supply connection 110 or the second power supply connection 120. The power supply connection 110, 120 with the greatest present current load or the greatest present power draw is shut off.

Not shown as a figure is a computer program product for avoiding a power supply unit overload. This comprises instructions that cause a device 100 to execute the method 800 according to FIG. 8.

In other words, the invention can be described as follows. In a SELV or PELV low-voltage system 700 with a DC voltage less than 60 VDC (direct current) of for example 12 VDC or 24 VDC, power supply connections (power supply elements) 110, 120 are used for electronic protection of loads 910, for example devices and lines. These power supply connections 110, 120 interrupt, like a fuse, the circuit when the rated current is exceeded, to protect the loads 910 (devices and lines) from overload. The rated or trigger current of the respective power supply connection 110, 120 is usually adjustable in different steps 510, 520, whereby it is generally possible and frequently the case that the sum of all rated currents is above the power capability (power capacity) of the upstream power supply unit 150.

If the rated currents of all power supply connections (power supply elements) 110, 120 are simultaneously fully utilized, there is basically the possibility that the power supply unit 150 is overloaded and thereby the voltage in the entire system 700, also called low-voltage system, must be reduced by power supply unit 150 and ultimately an undersupply of the circuits of all power supply connections 110, 120 and thus system downtime occurs.

Since in a known freely selectable combination of power supply unit 150 and device 100 (multi-channel selectivity module) there is no information exchange between both devices, the device 100 (multi-channel selectivity module) cannot prevent this system downtime by shutting off corresponding power supply connections 110, 120, since the rated currents of the individual power supply connections 110, 120 are not exceeded.

According to the invention, therefore, the information of the presently available power of the power supply unit 150 must be known to the device 100 (multi-channel selectivity module) so that it can react before a voltage reduction of the power supply unit 150 occurs.

For this purpose, the invention teaches a power supply unit 150 with integrated device 100 (multi-channel selectivity module), which transmits the present power capability of the power supply unit 150 via an internal interface from power supply unit 150 to device 210 (communication interface). Thereby, the integrated device 100 (multi-channel selectivity module) can use this information 210 to shut off the power supply connection (power supply element) 110, 120 with the presently highest output current before a voltage reduction occurs at the power supply unit 150. If the shutoff of a first power supply connection 110, 120 is not sufficient to ensure the maintenance of the power supply unit output voltage, a further power supply connection 110, 120 (of the remaining current-supplying power supply connections 110, 120) with the presently highest current consumption is shut off, until the total current consumption is sufficiently low. This ensures that the power supply unit 150 is operated within its specified power range.

It follows that an overload of the system 700 (overall apparatus consisting of power supply unit 150 and integrated device 10) is excluded, since in the cases
1. short circuit of a circuit of a power supply connection (power supply element) 110, 120,
2. exceeding the trigger current of a circuit of a power supply connection 110, 120, and
3. exceeding the available total power of the power supply unit 150
a shutoff of the at least one specific power supply connection 110, 120 takes place, which causes the risk of a voltage reduction.

In addition, the user can choose the type of prioritization himself. In the initial state, the power supply connection (power supply element) 110, 120 with the highest output current is shut off first. However, it is also possible to choose the shutoff according to different groups of power supply connections 110, 120, 610, 620. A different priority can be assigned to each of these groups, so that when a shutoff is necessary, power supply connections from the group with the lower priority are shut off first.

As an embodiment, a power supply with integrated 8-channel device 700 (multi-channel selectivity module) has a maximum power of 480 W at 24 VDC output voltage (rated current 20A). All 8 power supply connections 110, 120 are set to a rated current of 10 A. The individual circuits are loaded with the following currents:

| Power supply | | Present | |
|---|---|---|---|
| connection (power | Set rated | current | Shutoff |
| supply element) | current | load | priority |
| 1 | 10 A | 2 A | 4. |
| 2 | 10 A | 1.1 A | 6. |
| 3 | 10 A | 3 A | 3. |
| 4 | 10 A | 0.5 A | 8. |
| 5 | 10 A | 1.5 A | 5. |
| 6 | 10 A | 1 A | 7. |
| 7 | 10 A | 7 A | 1. (shut off) |
| 8 | 10 A | 4 A | 2. |

In this case, the power supply connection (power supply element) 110, 120 with number 7 would be shut off, since the highest current load is present there and the total current is 20.1 A. Thus, the current consumption (together with the associated output voltage) is above the maximum power of the power supply unit 150 and a voltage reduction threatens. After shutoff, the total current is 13.1 A and thus below the maximum power of the power supply unit.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMERALS

100 Inventive device
101 Known device
110 First power supply connection (power supply element)
112 Positive pole first power supply connection
114 First protection path
120 Second power supply connection (power supply element)
122 Positive pole second power supply connection
124 Second protection path
130 Receiving unit
135 Switch in the receiving unit
140 Controller
150 Inventive power supply unit
151 Known power supply unit
152 Device power supply
160 Negative pole power supply connections
170 Output current measurement first/second power supply connection
180 Shutoff element first power supply connection
185 Shutoff element second power supply connection
210 Interface power supply unit to device
220 Local power supply unit power capability setting in the device
410 Third power supply connection (power supply element)
412 Positive pole third power supply connection
414 Third protection path
480 Shutoff first power supply connection
510 Rated current adjustable in steps first power supply connection
520 Rated current adjustable in steps second power supply connection
610 First further power supply connection (power supply element)
620 Second further power supply connection (power supply element)
630 Priority power supply connections
640 Priority further power supply connections
700 System with device and power supply
710 Adjustable absolute output voltage
720 Integrated component comprising device and power supply unit
800 Method
810 Sensing a first current
820 Sensing a second current
830 Receiving a measured value
840 Controlling a shutoff
900 Prior art power supply unit and device, known system
910 Loads

1. A device for avoiding a power supply unit overload, comprising:
a first power supply connection of a first load;
a second power supply connection of a second load,
the first power supply connection and the second power supply connection are being electrically supplied by an upstream power supply unit;
a receiving unit configured to receive a measured value of a power capability of the upstream power supply unit; and
a controller that is configured to perform at least one shutoff of the first power supply connection or the second power supply connection upon exceeding the power capability of the upstream power supply unit,
wherein the power supply connection with a greatest present current load or the greatest present power draw is shut off.

2. The device of claim 1,
wherein:
the controller is configured to receive a measured value of the power capability of the upstream power supply unit via an interface of the receiving unit, and/or
the power capability of the upstream power supply unit is locally adjustable and/or stored in the receiving unit.

3. The device of claim 1,
wherein the power capability of the upstream power supply unit is variable as a variance.

4. The device of claim 1,
wherein the first power supply connection comprises a first protection path configured to prevent an exceedance of a first rated current, and
wherein the second power supply connection comprises a second protection path configured to prevent an exceedance of a second rated current, and
wherein the power capability of the upstream power supply unit is smaller than a sum of the first rated current and the second rated current.

5. The device of claim 1,
wherein the first protection path and/or the second protection path comprises an output current measurement via a shunt resistor or a Hall sensor.

6. The device according to 4, further comprising:
a third power supply connection of a third load, the third power supply connection comprising a third protection path configured to prevent an exceedance of a third rated current,
wherein, upon persistent exceedance of the power capability of the upstream power supply unit, the controller is configured to perform a shutoff of the power supply connection with a greatest present current load from a set of the non-shutoff power supply connections.

7. The device of claim 4, wherein:
the first rated current and the second rated current have an identical magnitude or at least partially mutually different magnitudes, and/or
wherein a magnitude of the first rated current and the second rated current is adjustable in steps.

8. The device of claim 1, further comprising:
further power supply connections,
wherein, for the further power supply connections, a user-selected priority is adjustable that is higher or lower than a priority of the power supply connections.

9. The device of claim 8,
wherein the controller is configured to perform at least one shutoff of the power supply connections or the further power supply connections of the priority upon exceeding the power capability of the upstream power supply unit,
wherein the power supply connections are shut off first at lower priority, and
wherein the further power supply connections are shut off first at lower priority.

10. The device according to claim 9,
wherein, for the power supply connections and the further power supply connections, the user-selected priority is adjustable via software or by a switch as a setting.

11. A system for avoiding a power supply unit overload, comprising:
the device of claim 1 and a power supply unit,
wherein the power supply unit and the device are electrically connected so as to supply the device with electrical power,
wherein the power supply unit and the device have a communication link, and
wherein a signal of the communication link includes information about the power capability of the power supply unit.

12. The system of claim 11, wherein the device and the power supply unit comprise an integrated component .

13. The system of claim 11,
wherein the upstream power supply unit is configured as constant-power.

14. A method for avoiding a power supply unit overload, the method comprising:
sensing a first current of a power supply connection of a first load;
sensing a second current of a second power supply connection of a second load,
the first power supply connection and the second power supply connection being electrically supplied by an upstream power supply unit,
receiving, with a receiving unit, a measured value for a power capability of the upstream power supply unit; and
controlling , with a controller, upon exceedance of the power capability of the upstream power supply unit, at least one shutoff of the first power supply connection or the second power supply connection ,
wherein the power supply connection with a greatest present current load or a greatest present power draw is shut off.

15. One or more transitory computer-readable mediums having processor-executable instructions stored thereon for avoiding a power supply unit overload, wherein the processor-executable instructions, when executed, facilitate performance of the method of claim 14.

16. The device of claim 3, wherein the variance is configured depending on:
a magnitude of a total current load,
a change in the total current load,
an ambient temperature,
the input voltage,
a prior loading, and/or
an absolute output voltage of the power supply unit.

17. The device of claim 5, wherein the output current measurement is evaluated in the controller taking into account a current reserve.

18. The device of claim 10, wherein, the setting is made at one of the further power supply connections.

19. The system of claim 13, wherein the upstream power supply unit has an adjustable absolute output voltage.
